(19) United States
(12) Patent Application Publication
(10) Pub. No.: US 2011/0162957 A1
(43) Pub. Date: Jul. 7, 2011

(54) SYSTEMS AND METHODS FOR ENHANCING GROWTH OF CARBON-BASED NANOSTRUCTURES

(75) Inventors: Brian L. Wardle, Lexington, MA (US); Stephen A. Steiner, III, Cambridge, MA (US); Desiree L. Plata, Holyoke, MA (US)

(73) Assignee: Massachusetts Institute of Technology, Cambridge, MA (US)

(21) Appl. No.: 12/953,287

(22) Filed: Nov. 23, 2010

Related U.S. Application Data
(60) Provisional application No. 61/264,506, filed on Nov. 25, 2009.

(51) Int. Cl. B01J 19/12; B82Y 40/00

(52) U.S. Cl. 204/157.63; 422/186; 977/901; 977/734

(57) ABSTRACT

Systems and methods generally directed to enhancing the growth of carbon-based nanostructures are described. In some embodiments, electromagnetic radiation can be used to enhance carbon-based nanostructure growth.

### RELATED APPLICATIONS

This application claims the benefit of U.S. Provisional Patent Application No. 61/264,506, filed Nov. 25, 2009, and entitled “Systems and Methods for Enhancing Growth of Carbon-Based Nanostructures,” which is incorporated herein by reference in its entirety for all purposes.

### FIELD OF INVENTION

Systems and methods generally directed to enhancing the growth of carbon-based nanostructures are described. In some embodiments, electromagnetic radiation can be used to enhance carbon-based nanostructure growth.

### BACKGROUND

The production of carbon-based nanostructures may potentially serve as an important tool in the production of emerging electronics and structural materials. Recent research has focused on the production of, for example, carbon nanotubes (CNTs) through chemical vapor deposition (CVD) and other techniques. The selection of appropriate growth conditions in which to form the nanostructures is important when designing carbon-nanostructure production processes. Many current methods exhibit limited yields and nanostructure sizes. In addition, in some cases, the selection of suitable materials for use in carbon-based nanostructure growth systems can be limited. Accordingly, improved systems and methods are desirable.

### SUMMARY

Systems and methods for enhancing growth of carbon-based nanostructures are generally described. The subject matter of the present invention involves, in some cases, interrelated products, alternative solutions to a particular problem, and/or a plurality of different uses of one or more systems and/or articles.

In one aspect, a method of growing carbon-based nanostructures is provided. In some embodiments, the method comprises providing a nanopositor; exposing the nanopositor to a precursor of a carbon-based nanostructure under conditions causing the formation of carbon-based nanostructures; and exposing at least one of the nanopositor and the precursor to electromagnetic radiation of intensity and energy selected to create a changed state of a component within the nanopositor, or a component in the precursor, or both, which changed state enhances formation of the carbon-based nanostructure.

The method comprises, in some embodiments, providing a nanopositor; exposing the nanopositor to a precursor of a carbon-based nanostructure under conditions causing the formation of carbon-based nanostructures; and exposing at least one of the nanopositor and the precursor to auxiliary electromagnetic radiation.

In one aspect, a system for growing carbon-based nanostructures is provided. In some embodiments, the system comprises a nanopositor; a precursor of a carbon-based nanostructure; and an auxiliary source of electromagnetic radiation constructed and arranged to expose at least one of the nanopositor and the precursor of a carbon-based nanostructure to a wavelength of electromagnetic radiation.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B include schematic illustrations of systems and methods for growing carbon-based nanostructures wherein a growth substrate is employed, according to one set of embodiments;

FIG. 2 includes an exemplary schematic illustration of carbon-based nanostructure growth in the absence of a growth substrate;

FIG. 3 includes a schematic illustration of a system for growing carbon-based nanostructures, according to one set of embodiments;

FIGS. 4A-4B include exemplary scanning electron microscope (SEM) images of carbon-based nanostructures; and

FIG. 5 includes a plot of XPS spectra during various phases of carbon-based nanostructure growth, according to one set of embodiments.

### DETAILED DESCRIPTION

Systems and methods for enhancing growth of carbon-based nanostructures are generally described. In some embodiments, a nanopositor can be exposed to a precursor of a carbon-based nanostructure under conditions causing the formation of carbon-based nanostructures. Electromagnetic radiation can be used, in some cases, to enhance carbon-based nanostructure growth. For example, in some cases, at least one of the nanopositor and the precursor can be exposed, during the growth of carbon-based nanostructures, to electromagnetic radiation of intensity and energy selected to create a changed state of a component within the nanopositor, a component in the precursor, or both. The intensity, energy, and wavelength of the electromagnetic radiation used can be selected, in some cases, based upon the type of nanopositor or precursor material that is used. In some cases, the electromagnetic radiation can be auxiliary electromagnetic radiation (i.e., the electromagnetic radiation can originate from an auxiliary source).

Advantageously, the systems and methods described herein can be used to produce relatively high yields of carbon-based nanostructures, in some cases. Moreover, relatively large carbon-based nanostructures (e.g., relatively long carbon-based nanostructures, relatively large-diameter carbon-based nanostrucutres, etc.) can be produced in some embodiments. In many cases, the advantages described herein can be achieved without the addition of costly equipment, and the systems and methods can be relatively easy to implement. Additional advantages of the systems and methods associated with the use of electromagnetic radiation to enhance nanostructure growth are described in more detail below.

In one aspect, methods of growing carbon-based nanostructures are described. As used herein, the term “carbon-based nanostructure” refers to articles having a fused network of aromatic rings, at least one cross-sectional dimension of less than about 1 micron, and comprising at least about 30% carbon by mass. In some embodiments, the carbon-based nanostructures may comprise at least about 40%, at least about 50%, at least about 60%, at least about 70%, at least about 80%, at least about 90%, or at least about 95% of carbon by mass, or more. The term “fused network” might not include, for example, a biphenyl group, wherein two phenyl rings are joined by a single bond and are not fused. Example of carbon-based nanostructures include carbon nanotubes (e.g., single-walled carbon nanotubes, double-walled carbon nanotubes, multi-walled carbon nanotubes, etc.), carbon nanowires, carbon nanofibers, carbon nanoshells, graphene, fullerenes, and the like.

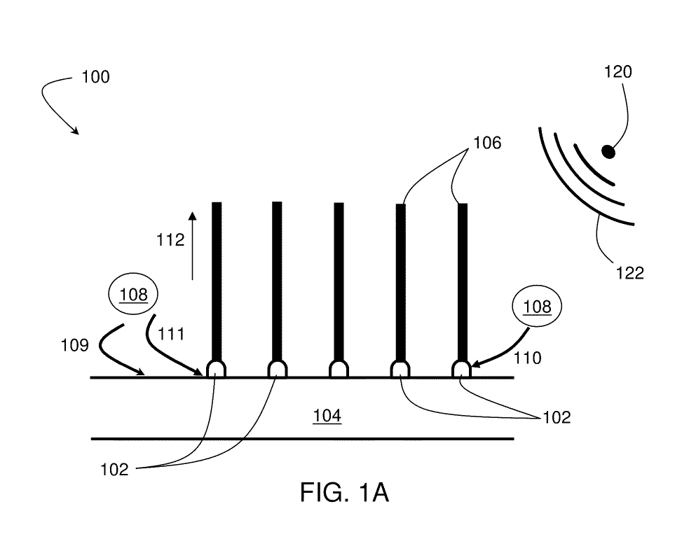

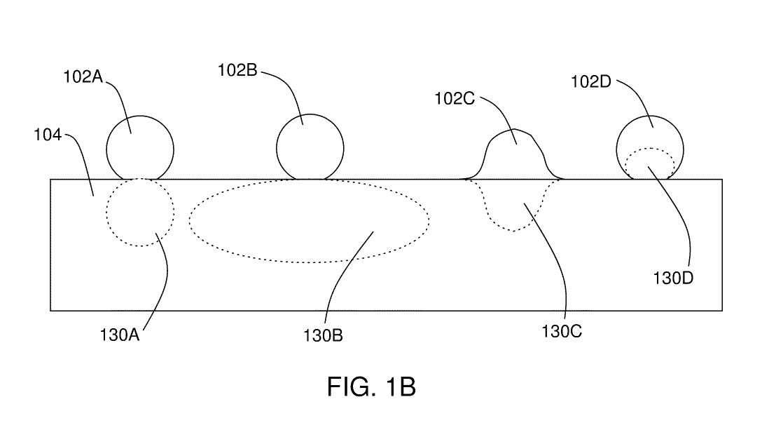

FIG. 1A includes a schematic illustration of an exemplary system 100 in which carbon-based nanostructures can be grown. In one set of embodiments, the method includes exposing a nanopositor to a precursor of a carbon-based nanostructure under conditions causing the formation of carbon-based nanostructures. As used herein, the term “nanopositor” refers to a material that, when exposed to a set of conditions selected to cause formation of nanostructures, either enables formation of nanostructures that would otherwise not occur in the absence of the nanopositor under essentially identical conditions, or increases the rate of formation of nanostructures relative to the rate that would be observed under essentially identical conditions but without the nanopositor material. “Essentially identical conditions,” in this context, means conditions that are similar or identical (e.g., pressure, temperature, composition and concentration of species in the environment, etc.), other than the presence of the nanopositor. In some cases, the nanopositor is not consumed in a reaction involving the formation of the nanostructures which it enables or for which it increases the rate (i.e., in some embodiments, atoms or molecules that make up the nanopositor are not, via reaction, incorporated into the nanostructure). A variety of nanopositors are suitable for use in the systems and methods described herein, as described in more detail below. A nanopositor can also be referred to as an “active growth structure.” In some embodiments, the nanopositor can be catalytic. It should be understood that while, in some embodiments, a nanopositor can have one or more nanoscale dimensions, the nanopositors described herein are not so limited, and, in some cases, the smallest dimension (e.g., smallest cross-sectional dimension) of a nanopositor is on the order of a micron, millimeter, centimeter, or longer.

In the set of embodiments illustrated in FIG. 1A, nanopositor 102 (e.g., a nanopositor nanoparticle) is positioned on the surface of growth substrate 104. In addition, a precursor 108 of a carbon-based nanostructure, can be delivered to growth substrate 104 and/or nanopositor 102 and contact or permeate the growth substrate surface (e.g., via arrow 109), the nanopositor surface (e.g., via arrow 110), and/or the interface between the nanopositor and the growth substrate (e.g., via arrow 111). Nanostructure precursor materials may be of any suitable phase (e.g., solid, fluid) and include, for example, hydrocarbons (e.g., alkanes, alkenes, alkynes, etc.), hydrogen, alcohols, and the like. In the growth of carbon nanotubes, for example, the nanostructure precursor material may comprise carbon, such that carbon dissociates from the precursor molecule and may be incorporated into the growing carbon nanotube, which is pushed upward from the growth substrate in general direction 112 with continued growth.

In some embodiments, one or more components of the growth system (e.g., a component in the nanopositor, a component in the precursor, the nanopositor support (e.g., a growth substrate, a porous particle support), any combination of these) can be exposed to electromagnetic radiation. The set of embodiments illustrated in FIG. 1A, for example, includes electromagnetic radiation source 120 from which electromagnetic radiation 122 is emitted. In this set of embodiments, any of substrate 104, nanopositor 102, and precursor 108 can be exposed to electromagnetic radiation 122.

The electromagnetic radiation can, in some instances, be of intensity and energy selected to create a changed state of a component within the nanopositor. In some embodiments, the changed state can be an electronically excited state. Generally, an electronically excited state is understood by those of ordinary skill in the art to describe a state in which at least one electron is transferred from a relatively low-energy state to a higher energy state. The changed state can comprise, in some embodiments, the formation of an electron-hole pair within the nanopositor (e.g., on the surface of the nanopositor). In some cases, the changed state can comprise the formation of one or more defects within a nanopositor (e.g., on the surface of the nanopositor). Changes in state can also comprise, in some embodiments, the formation of charge states (e.g., on the surface of a nanopositor), a change in acidity, a change of shape, a change of oxidation state, or a change in composition. In some embodiments, a change in state can comprise a change in the crystal phase (e.g., in a substantially pure solid, in a solid solution) of the nanopositor. In embodiments where a solid precursor is employed, the electromagnetic radiation can, in some cases, be of intensity and energy selected to create a changed state of a component within the precursor (e.g., any of the changed states described herein).

In some embodiments, the electromagnetic radiation can include photons with energies exceeding the bandgap energy of a component of the nanopositor and/or precursor (e.g., in the case of a solid precursor). For example, in some cases zirconia can be used as a nanopositor, and the electromagnetic radiation can include photons with energies exceeding 5-7 eV (the approximate range of bandgaps of zirconia, depending on phase). As another example, in some embodiments, iron(II) sulfide (FeS) can be used in a nanopositor, and the electromagnetic radiation can include photons with energies exceeding 0.95 eV (the approximate bandgap of FeS). In some embodiments, the electromagnetic radiation comprises photons with energies substantially equal to the bandgap energy of a component of the nanopositor (e.g., about 5.3 eV for some phases of zirconia, about 0.95 eV for FeS). Not wishing to be bound by any theory, a hole-electron pair may appear within the nanopositor (e.g., at the surface) upon being exposed to electromagnetic radiation. The hole and/or electron may participate in various reactions with incoming vapor-phase species, and/or solid-phase species adsorbed on the nanopositor surface, and/or at the triple-phase boundary of a gas (or solid), the nanopositor, and a nanopositor support surface (described below) thereby facilitating CNT growth.

In some embodiments, the electromagnetic radiation can be of intensity and energy selected to create a changed state (e.g., an electronically excited state) of a component within the precursor of the carbon-based nanostructures. In some cases, the electromagnetic radiation can include photons with wavelengths substantially equal to a characteristic absorption wavelength of a component of the precursor of a carbon-based nanostructure. The electromagnetic radiation can include, in some cases, photons with energies exceeding the bandgap of a component within the precursor (e.g., a solid precursor). For example, the precursor of the carbon-based nanostructures can include nanodiamond, in some cases, and the electromagnetic radiation can include photons with energies exceeding the bandgap of the nanodiamond.

In some cases, for a given nanopositor, precursor, and/or nanopositor support the energy and/or intensity of the electromagnetic radiation to which the nanopositor and/or precursor is exposed can be controlled, to at least some degree, such that a changed state of a component of the nanopositor and/or precursor is achieved. The energy of the electromagnetic radiation can be controlled, for example, by controlling the wavelengths of the electromagnetic radiation to which the nanopositor, precursor, and/or nanopositor support is exposed (e.g., by modulating the source generating the electromagnetic radiation, by filtering the electromagnetic radiation, etc.). Intensity can be controlled, for example, by modulating the power applied to the source of electromagnetic radiation. In some embodiments, selecting an intensity or energy of electromagnetic radiation can comprise determining a property of the growth system or nanostructures (e.g., presence of carbon-based nanostructures, growth rate, yield, length or other size of the nanostructures, etc.), and controlling the intensity and/or energy of the electromagnetic radiation, at least in part, based upon the determination. The term “determining,” as used herein, generally refers to the measurement and/or analysis of an article (e.g., a nanostructure), for example, quantitatively or qualitatively, or the detection of the presence or absence of the article. For example, in some embodiments, the intensity or energy of the electromagnetic radiation can be modulated to increase a yield or dimension (e.g., length, average maximum cross-sectional dimension, average maximum cross-sectional diameter, average maximum cross-sectional inner diameter, etc.) of the carbon-based nanostructures.

In some cases, the electromagnetic radiation to which one or more components of the system are exposed can include a selected range of wavelengths. For example, in some embodiments, the electromagnetic radiation includes one or more wavelengths shorter than visible light. In some cases, the electromagnetic radiation can include ultraviolet electromagnetic radiation. X-ray electromagnetic radiation can also be employed, in some embodiments. In some cases, a large percentage of the electromagnetic radiation (e.g., auxiliary electromagnetic radiation) to which one or more components of the system are exposed can fall within a range. For example, in some embodiments, at least about 50%, at least about 75%, at least about 90%, at least about 95%, at least about 99%, at least about 99.9%, or substantially all of the electromagnetic radiation (e.g., auxiliary electromagnetic radiation) to which one or more components is exposed can have a wavelength of less than about 450 nm, less than about 400 nm, less than about 1 nm, between about 0.01 nm and about 450 nm, between about 1 nm and about 450 nm, between about 10 nm and about 450 nm, or between about 10 nm and about 400 nm. In some embodiments, at least about 50%, at least about 75%, at least about 90%, at least about 95%, at least about 99%, at least about 99.9%, or substantially all of the radiation to which one or more components is exposed can be either X-ray or ultraviolet electromagnetic radiation. In some cases, at least about 50%, at least about 75%, at least about 90%, at least about 95%, at least about 99%, at least about 99.9%, or substantially all of the radiation (e.g., auxiliary electromagnetic radiation) to which one or more components is exposed can be ultraviolet electromagnetic radiation.

The electromagnetic radiation can, in some cases, be auxiliary electromagnetic radiation emitted from an auxiliary source. In the set of embodiments illustrated in FIG. 1A, for example, electromagnetic radiation 122 can be auxiliary electromagnetic radiation, and source 120 can be an auxiliary source. “Auxiliary electromagnetic radiation” generally refers to electromagnetic radiation from a source (i.e., an “auxiliary source” of electromagnetic radiation) that is not an inherent source but is a source used for the purpose of specifically directing the radiation (e.g., ultraviolet light, X-ray radiation, etc.) at the growth system. One of ordinary skill in the art would clearly recognize a source used for this purpose and, in contrast, would be able to identify inherent sources of electromagnetic radiation such as, for example, sunlight, lights used to illuminate a room, electromagnetic radiation inherently emitted upon heating a component of the growth system (e.g., a nanopositor support such as a substrate), and the like. Exemplary auxiliary sources of electromagnetic radiation can include, but are not limited to, lamps (e.g., ultraviolet lamps, light bulbs, etc.), lasers, X-ray guns, and the like.

In some embodiments, exposure of the nanopositor, precursor, and/or nanopositor support to electromagnetic radiation (e.g., auxiliary electromagnetic radiation having any of the properties described herein) can enable formation of nanostructures that would otherwise not substantially occur in the absence of the electromagnetic radiation, but under essentially identical conditions. In this context, “otherwise essentially identical conditions” means that the conditions of growth (e.g., temperature, pressure, nanopositor type, precursor type and concentration, etc.) are identical, but the system is not exposed to the electromagnetic radiation with the properties described herein (e.g., auxiliary electromagnetic radiation having any of the properties described herein).

In some embodiments, the embodiments described herein may be capable of achieving enhanced growth of carbon-based nanostructures. For example, in some cases, enhanced yields can be achieved. The yield of carbon-based nanostructures can be, in some instances, at least about 25%, at least about 50%, at least about 75%, at least about 100%, at least about 250%, at least about 500%, at least about 1000%, at least about 2500%, or at least about 5000% higher (on a mass basis) than the yield achievable in the absence of electromagnetic radiation (e.g., auxiliary electromagnetic radiation), but under otherwise essentially identical conditions.

The embodiments described herein may also be capable of producing carbon-based nanostructures with relatively large dimensions (e.g., lengths, longest cross-sectional dimensions, etc.). In some embodiments, the average length and/or longest cross-sectional dimension of the carbon-based nanostructures can be at least about 25%, at least about 50%, at least about 75%, at least about 100%, at least about 250%, at least about 500%, at least about 1000%, at least about 2500%, or at least about 5000% longer than the average lengths and/or largest cross-sectional dimensions achievable in the absence of electromagnetic radiation (e.g., an auxiliary electromagnetic radiation), but under otherwise essentially identical conditions. In some cases, the average length and/or longest cross-sectional dimension of a plurality of carbon-based nanostructures that are produced is at least about 1 mm, at least about 1 cm, at least about 10 cm, at least about 100 cm.

In some cases, the embodiments described herein can be used to produce elongated carbon-based nanostructures (e.g., carbon nanotubes, carbon nanowires, etc.) with relatively large diameters. For example, in some embodiments, the average maximum cross-sectional diameter of the plurality of elongated carbon-based nanostructures can be at least about 25%, at least about 50%, at least about 75%, at least about 100%, at least about 250%, at least about 500%, at least about 1000%, at least about 2500%, or at least about 5000% larger than the average maximum cross-sectional diameters achievable in the absence of electromagnetic radiation (e.g., auxiliary electromagnetic radiation), but under otherwise essentially identical conditions. In some embodiments, the average maximum cross-sectional inner diameter of a plurality of carbon nanotubes produced using the embodiments described herein can be at least about 25%, at least about 50%, at least about 75%, at least about 100%, at least about 250%, at least about 500%, at least about 1000%, at least about 2500%, or at least about 5000% larger than the average maximum cross-sectional inner diameter achievable in the absence of electromagnetic radiation (e.g., auxiliary electromagnetic radiation), but under otherwise essentially identical conditions.

A variety of suitable precursors of carbon-based nanostructures can be used in association with the systems and methods described herein. Those of ordinary skill in the art would be able to select the appropriate precursor for the growth of a particular carbon-based nanostructure. In some embodiments, the precursor of a carbon-based nanostructure can be a fluid (e.g., a solid, a gas, a supercritical fluid, etc.). For example, carbon nanotubes may be synthesized by reaction of a C₂H₄/H₂ mixture with a nanopositor, such as nanoparticles of zirconium oxide arranged on a carbon fiber nanopositor support. Other examples of precursors of carbon-based nanostructures that may be used include, for example, alkanes (e.g., methane), alkenes e.g., (1,3-cyclopentadiene), alkynes (e.g., acetylene, 1-propyne, 1,3-butadiyne, but-1-en-3-yne,), esters (e.g., methyl formate), alcohols (e.g., ethanol), and the like. In one set of embodiments, the nanostructure precursor material can be a solid. Examples of solid precursor materials include, for example, coal, coke, amorphous carbon, unpyrolyzed organic polymers (e.g., phenol-formaldehyde, resorcinol-formaldehyde, melamine-formaldehyde, etc.) partially pyrolyzed organic polymers, graphite, or any other suitable solid form of carbon. In some embodiments, the solid precursor can include diamond. As a specific example, a diamond precursor can, in some cases, interact with a nanopositor including a zero oxidation state metal to form graphene. In some embodiments, the solid precursor material may comprise at least about 25 wt % carbon, at least about 50 wt % carbon, at least about 75 wt % carbon, at least about 85 wt % carbon, at least about 90 wt % carbon, at least about 95 wt % carbon, at least about 98 wt % carbon, or at least about 99 wt % carbon.

A variety of nanopositors can be used in accordance with the embodiments described herein. The nanopositor can comprise a crystalline material (e.g., a single-crystal material, a polycrystalline material, etc.), an amorphous material, or mixtures of these.

In some cases (e.g., when a zero-oxidation state metal is used as a nanopositor), the nanopositor can be in contact with a nanopositor support. Examples of nanopositor supports can include, for example, porous structures within which nanopositor material is deposited, for example, to increase the surface area of the nanopositor material available for interaction with a precursor of carbon-based nanostructures. In some cases, the nanopositor support may be a substrate in contact with the nanopositor. In some embodiments, the nanopositor support can be made of a different material than the nanopositor it contacts. For example, in some cases, the nanopositor can include a metal in a zero oxidation state during growth, and the nanopositor support may contain a metal atom in a non-zero oxidation state during growth (e.g., an oxide, nitride, phosphide, carbide, chalcogenide, silicide, etc.). In some embodiments, the nanopositor support may include one or more crystal defects. Not wishing to be bound by any theory, introduction of defects into a nanopositor support (e.g., oxides, nitrides, phosphides, carbides, chalcogenides, silicides, and the like) may decrease the width of the bandgap of the nanopositor support, allowing it to interact with electromagnetic radiation in a different manner relative to the interaction that would be observed in the absence of the defects.

In some cases, a triple-phase boundary can be formed between the nanopositor, the nanopositor support, and the precursor of a carbon-based nanostructure. The formation of the triple-phase boundary may enhance the nanostructure yield and/or the average length of resultant nanostructures, relative to a yield and/or average length that would be observed in the absence of the triple-phase boundary, but under otherwise essentially identical conditions.

In some embodiments, the nanopositor can be selected such that the bandgap energy of a component of the nanopositor is less than the energy of at least a portion of the photons within the electromagnetic radiation (e.g., auxiliary electromagnetic radiation) to which the nanopositor is exposed. In some cases, the nanopositor (or a component thereof) may have a bandgap energy of between about 0.5 eV and about 9 eV, between about 3 eV and about 7 eV, or between about 3 eV and about 5 eV. In some cases, the nanopositor can be selected such that the bandgap of the nanopositor material is smaller than the energy of photons within visible light, smaller than the energy of photons within ultraviolet light, or smaller than the energy of photons within x-rays.

In some embodiments, the nanopositor can include a metal in a zero-oxidation state (e.g., during growth of the nanostructures). Exemplary zero oxidation state metals include, but are not limited to, iron, cobalt, nickel, platinum, gold, copper, rhenium, tin, tantalum, aluminum, palladium, rhodium, silver, tungsten, molybdenum, zirconium, or any other suitable metal.

The nanopositor, or a nanopositor support, can include, in some cases, metal or metalloid atoms in a non-zero oxidation state (e.g., during growth of the carbon-based nanostructures). Such nanopositors can be useful, for example, when nanopositor supports, such as growth substrates comprising carbon or other materials with which zero oxidation state metals, can react during nanostructure formation are used. The use of non-zero oxidation state metals can preserve the integrity of such nanopositor supports (e.g., growth substrates) during growth, in some cases. In some instances, the nanopositor and/or nanopositor support may comprise metal oxides or metal chalcogenides (e.g., metal sulfides, metal selenides, metal tellurides, etc.). In some embodiments, the nanopositor or nanopositor support may comprise metalloid oxides or metalloid chalcogenides (e.g., metalloid sulfides, metalloid selenides, metalloid tellurides, etc.). In some cases, the nanopositor or nanopositor support may comprise a metal and/or metalloid carbide, nitride, phosphide, silicide, or combination of these. Examples of metal atoms in a non-zero oxidation state which may be particularly suitable, in some embodiments, for use in nanopositors or nanopositor supports include, but are not limited to, oxide and chalcogenide forms of zirconium, hafnium, tantalum, niobium, yttrium, lanthanum, molybdenum, lanthanide metals, titanium, aluminum, rhenium, and calcium, among others. Examples of metalloid atoms in a non-zero oxidation state which may be particularly suitable, in some embodiments, for use in nanopositors or nanopositor supports include, but are not limited to, silicon and germanium among others. Specific examples of suitable nanopositors include, but are not limited to, zirconia, doped zirconia, titania, doped titania (e.g., Sn-doped titania), MoO₃/ZrO₂ blends, FeS, and Si₃N₄.

The nanopositor or nanopositor support may comprise, in some embodiments, metal or metalloid atoms that are non-carbidic (e.g., the metal or metalloid does not form a carbide, for example, under the conditions at which the carbon-based nanostructures are formed). In some embodiments, the nanopositor or nanopositor support may include metal or metalloid atoms that do not form a carbide at temperatures up to 1050° C. In some embodiments, the nanopositor or nanopositor support may include more than one oxide, more than one chalcogenide, or a combination of at least one oxide and at least one chalcogenide. For example, in some embodiments, the nanopositor or nanopositor support may comprise zirconium oxide and molybdenum oxide, zirconium oxide and calcium oxide, or zirconium oxide an zirconium sulfide.

In some embodiments, a relatively large percentage of the metal or metalloid atoms in the nanopositor or nanopositor support are in a non-zero oxidation state (e.g., during growth of the nanostructures). For example, in some embodiments, at least about 25%, at least about 35%, at least about 50%, at least about 65%, at least about 75%, at least about 85%, at least about 95%, at least about 98%, at least about 99%, at least about 99.5%, at least about 99.9%, or more of the metal or metalloid atoms in the nanopositor or nanopositor support are in a non-zero oxidation state. In some cases, substantially all of the metal or metalloid atoms in the nanopositor or nanopositor support are in a non-zero oxidation state. The percentage of atoms with a specified oxidation state may be determined, for example, via X-ray photoelectron spectroscopy (XPS).

In some embodiments, the nanopositor may include diamond (e.g., nanodiamond). For example, in some cases, a nanopositor including diamond may be exposed to a precursor (e.g., a hydrocarbon), and nanostructures can be formed, in some cases without substantially consuming any of the diamond.

One or more dopant elements may be included in the nanopositor, in some embodiments. In some cases, the nanopositor support may include one or more dopants, in place of or in addition to dopants within the nanopositor. In some embodiments, a doped nanopositor support may be used to support a nanopositor that does not exhibit a significant response to electromagnetic radiation (e.g., at the selected intensity, wavelength, etc.). In such cases, the doped nanopositor support may experience a changed state in response to exposure to electromagnetic radiation. Examples of dopant elements that may be included in the nanopositor or nanopositor support include, for example, Ca, Mg, Sr, Ba, Y, Sn, Mo, or other elements, or combinations of these and/or other elements. As a specific example, the nanopositor may comprise zirconium oxide doped with calcium (e.g., 1.5 atomic % calcium). In some embodiments, the nanopositor support may include a metal or metalloid oxide (e.g., alumina, silica) doped with calcium. In some cases, the nanopositor or nanopositor support may comprise less than about 50 atomic %, less than about 35 atomic %, less than about 20 atomic %, less than about 10 atomic %, less than about 5 atomic %, less than about 2 atomic %, less than about 1.5 atomic %, less than about 1 atomic %, or less than about 0.5 atomic %, between about 0.1 atomic % and about 5 atomic %, between about 0.5 atomic % and about 3 atomic %, or between about 1 atomic % and about 2 atomic % dopant elements. The dopant element may, in some embodiments, be integrated into the nanopositor or nanopositor support such that the dopant atoms reside within interstices of a crystalline material. In some cases, a dopant atom may replace an atom in the crystal structure of a nanopositor or nanopositor support. Not wishing to be bound by any theory, the inclusion of dopant atoms in the nanopositor or nanopositor support may have any one of the following benefits: enhancement of acidity, invocation of n-type or p-type doping, or acid-base pair formation on a surface of the nanopositor.

In some embodiments, the nanopositor is in contact with a portion of a nanopositor support (e.g., growth substrate) comprising a material that is different from the nanopositor (e.g., the portion of the nanopositor in contact with the nanopositor support (e.g., growth substrate)). For example, in some cases, the nanopositor may comprise a metal oxide (e.g., a zirconium oxide), while the portion of the nanopositor support (e.g., growth substrate) in contact with the metal oxide comprises carbon, a metal, silicon, or any other suitable material that is not a metal oxide. As another example, the nanopositor may comprise a metalloid oxide (e.g., a silicon oxide), while the portion of the nanopositor support (e.g., growth substrate) in contact with the metalloid oxide comprises carbon, a metal, silicon, or any other suitable material that is not a metalloid oxide. In some cases the nanopositor is in contact with a portion of the nanopositor support (e.g., growth substrate) comprising a material that is the same as the nanopositor (e.g., the portion of the nanopositor in contact with the nanopositor support (e.g., growth substrate)).

In some embodiments, the nanopositor or nanopositor support may comprise a metal or metalloid atom in a non-zero oxidation state that is bonded (e.g., ionically, covalently, etc.) to a more electronegative element in a stoichiometric form. For example, the nanopositor or nanopositor support may comprise a stoichiometric oxide, chalcogenide, etc. One of ordinary skill in the art would be capable of identifying a stoichiometric form of such molecules. For example, a stoichiometric form of zirconium oxide is ZrO₂. A stoichiometric form of aluminum oxide is Al₂O₃. In some cases, the nanopositor or nanopositor support may comprise a metal or metalloid atom in a non-zero oxidation state that is bonded (e.g., ionically, covalently, etc.) to a more electronegative element in non-stoichiometric form. The nanopositor or nanopositor support may comprise such non-stoichiometric forms when, for example, the electropositive element is present in excess or shortage relative to the amount of one or more electronegative elements that would be observed in a stoichiometric form. For example, in cases where the nanopositor or nanopositor support comprises an oxide, the oxide may be oxygen-rich or oxygen-deficient. In some cases, non-stoichiometric forms may arise from inclusion of dopants in the nanopositor or nanopositor support. For example, non-stoichiometry may be observed due to the inclusion of less than about 50%, less than about 35%, less than about 20%, less than about 10%, less than about 5%, less than about 2%, less than about 1%, or less than about 0.5% Ca, Mg, Sr, Ba, Y, Mo, Sn, or other elements, or combinations of these and/or other elements.

The nanopositor or nanopositor support may comprise zirconium oxide, in some embodiments. The zirconium oxide nanopositor or nanopositor support may be stoichiometric (e.g., ZrO₂) or non-stoichiometric. In some embodiments, the zirconium oxide may form a metastable oxygen-deficient state. A material is said to be in an oxygen-deficient state when it comprises an amount of oxygen less than what would be present in the material's stoichiometric form. In some embodiments, the zirconium oxide may comprise an oxygen to zirconium ratio ranging from about 1.0 to about 2.0 (i.e., ZrO_{1.0-2.0}), from about 1.6 to about 2.0 (i.e., ZrO_{1.6-2.0}), from about 1.6 to about 1.8 (i.e., ZrO_{1.6-1.8}), or from about 1.0 to about 1.6 (i.e., ZrO_{1.0-1.6}). In some embodiments, the zirconium oxide may be a suboxide, for example, with a formula of ZrO. In some embodiments, the zirconium oxide may be a superoxide (i.e., the ratio of oxygen to zirconium in the zirconium oxide is greater than about 2:1).

In some embodiments, oxides can include lanthanum oxide, hafnium oxide, tantalum oxide, niobium oxide, molybdenum oxide, and yttrium oxide. Not wishing to be bound by any theory, these oxides may be particularly suitable, in some embodiments, due to their proximity to zirconium on the periodic table. Metalloid oxides may comprise, for example, silicon oxide, germanium oxide, and the like.

In some embodiments, the metal or metalloid atoms in a non-zero oxidation state in the nanopositor or nanopositor support are not reduced to a zero oxidation state during formation of the nanostructures. In some embodiments, fewer than about 2%, fewer than about 1%, fewer than about 0.1%, or fewer than about 0.01% of the metal or metalloid atoms in a non-zero oxidation state in the nanopositor or nanopositor support are reduced to a zero-oxidation state during formation of the nanostructures. In some embodiments, substantially none of the metal or metalloid atoms in a non-zero oxidation state in the nanopositor or nanopositor support are reduced to a zero-oxidation state during formation of the nanostructures.

In some instances, the metal or metalloid atoms in a non-zero oxidation state do not form carbides during the formation of the nanostructures. In some embodiments, fewer than about 2%, fewer than about 1%, fewer than about 0.1%, or fewer than about 0.01% of the metal or metalloid atoms in a non-zero oxidation state in the nanopositor or nanopositor support are form carbides during formation of the nanostructures. In some embodiments, substantially none of the metal or metalloid atoms in a non-zero oxidation state in the nanopositor or nanopositor support form carbides during formation of the nanostructures.

Process conditions, nanopositor supports, and/or nanopositors can be chosen, in some instances, such that the metal or metalloid atoms in a non-zero oxidation state in the nanopositor or nanopositor support are not reduced to a zero oxidation state and do not form carbides (or are done so only to a relatively small degree) during formation of the nanostructures. For example, in one set of embodiments, the nanopositor or nanopositor support comprises zirconium oxide, and the process temperature is selected such that neither zero-oxidation-state zirconium (e.g., metallic zirconium) nor zirconium carbide are formed during formation of the nanostructures. In some embodiments, the nanostructures are formed at a temperature below about 1100° C., below about 1050° C., below about 1000° C., below about 900° C., below about 800° C., below about 700° C., below about 600° C., below about 500° C., below about 400° C., above about 300° C., above about 400° C., above about 500° C., above about 600° C., above about 700° C., above about 800° C., above about 900° C., above about 1000° C., above about 1050° C., or between about 300° C. and about 500° C., between about 300° C. and about 1100° C., between about 300° C. and about 1050° C., between about 300° C. and about 1000° C., between about 300° C. and about 900° C., between about 300° C. and about 500° C., between about 500° C. and about 900° C., between about 500° C. and about 1000° C., between about 500° C. and about 1050° C., or between about 500° C. and about 1100° C., and the metal or metalloid atoms in a non-zero oxidation state in the nanopositor or nanopositor support are not reduced to a zero oxidation state and do not form a carbide during formation of the nanostructures.

In some embodiments, the nanopositor, the nanopositor support (e.g., growth substrate), and/or the conditions under which the nanostructures are grown are selected such that the amount of chemical interaction or degradation between the nanopositor support and the nanopositor is relatively small. For example, in some cases, the nanopositor does not diffuse significantly into or significantly chemically react with the nanopositor support (e.g., growth substrate) during formation of the nanostructures. One of ordinary skill in the art will be able to determine whether a given nanopositor has diffused significantly into or significantly chemically reacted with a nanopositor support (e.g., growth substrate). For example, X-ray photoelectron spectroscopy (XPS), optionally with depth profiling, may be used to determine whether a nanopositor has diffused into a nanopositor support (e.g., growth substrate) or whether elements of the nanopositor support (e.g., growth substrate) have diffused into the nanopositor. X-ray diffraction (XRD), optionally coupled with XPS, may be used to determine whether a nanopositor and a nanopositor support (e.g., growth substrate) have chemically reacted with each other. Secondary ion mass spectroscopy (SIMS) can be used to determine chemical composition as a function of depth.

FIG. 1B illustrates a set of embodiments in which nanopositor 102 can interact with substrate 104. The volume within which the nanopositor interacts with the substrate is shown as volumes 130A-D. In FIG. 1B, spherical nanopositor 102A interacts with substrate 104 over volume 130A, which is roughly equivalent to the original volume of nanopositor 102A. Spherical nanopositor 102B interacts with substrate 104 over volume 130B, which is roughly equivalent to three times the original volume of nanopositor 102B. Wetted nanopositor 102C is shown interacting with substrate 104 over volume 130C, which is roughly equivalent to the original volume of nanopositor 102C. In addition, substrate 104 is illustrated diffusing into nanopositor 102D, with the interaction volume indicated as volume 130D.

In some embodiments, chemical reaction between the nanopositor and the nanopositor support (e.g., growth substrate) may occur, in which case the volume within which the nanopositor and the nanopositor support interact is defined by the volume of the reaction product. The volume of the chemical product may be determined, for example, via XPS analysis, using XRD to determine the chemical composition of the product and verify that it originated from the nanopositor. In some embodiments, the nanopositor may diffuse into the nanopositor support or the nanopositor support may diffuse into the nanopositor, in which case the volume within which the nanopositor and the nanopositor support interact is defined by the volume over which the nanopositor and/or the nanopositor support diffuses. The volume over which a nanopositor diffuses can be determined, for example, using XPS with depth profiling.

In some embodiments, the volume within which the nanopositor interacts with the nanopositor support, such as a growth substrate (e.g., the volume of the product produced via a chemical reaction between the nanopositor and the nanopositor support, the volume over which the nanopositor and/or the nanopositor support diffuses into the other, etc.) is relatively small compared to the original volume of the nanopositor as formed on the nanopositor support. In some instances, the volume of the nanopositor as formed on the nanopositor support is at least about 0.1%, at least about 0.5%, at least about 1%, at least about 5%, at least about 10%, at least about 25%, at least about 50%, at least about 100%, at least about 200%, at least about 500%, at least about 2500%, at least about 5000%, at least about 10,000%, at least about 50,000%, or at least about 100,000% greater than the volume within which the nanopositor interacts with the nanopositor support (e.g., via reaction, via diffusion, via a combination of mechanisms, etc.).

In some embodiments, the mass percentage of the nanopositor that interacts with the nanopositor support (e.g., via reaction of the nanopositor and the nanopositor support, diffusion of the nanopositor into the nanopositor support, diffusion of the nanopositor support into the nanopositor, or a combination of these) is relatively low. In some embodiments, less than about 50 atomic %, less than about 25 atomic %, less than about 10 atomic %, less than about 5 atomic %, less than about 2 atomic %, or less than about 1 atomic % of the nanopositor as formed on the nanopositor support interacts with the nanopositor support. The percentage of the nanopositor that interacts with the nanopositor support can be determined, for example, using XPS with depth profiling. Optionally, XRD can be employed to determine the composition of the measured material.

Interaction between the nanopositor and the nanopositor support may be determined, in some embodiments, by measuring the conductivity of the nanopositor support before and after the growth of the nanostructures. In some cases, the resistance of the nanopositor support does not change by more than about 100%, by more than about 50%, by more than about 25%, by more than about 10%, by more than about 5%, or by more than about 1% relative to the resistance of a nanopositor support exposed to essentially identical conditions in the absence of the nanopositor. “Essentially identical conditions,” in this context, means conditions that are similar or identical, other than the presence of the nanopositor. For example, otherwise identical conditions may refer to a nanopositor support that is identical and an environment that is identical (e.g., identical temperature, pressure, gas composition, gas concentration, other processing conditions, etc.), but where the nanopositor is not present. Suitable techniques for measuring the resistance of a nanopositor support are described, for example, in ASTM Designation: D 257-99, entitled “Standard Test Methods for DC Resistance or Conductance of Insulating Materials” (Reapproved 2005), which is incorporated herein by reference in its entirety.

In some cases, the interaction of the nanopositor and the nanopositor support may be determined by measuring the tensile strength of the nanopositor support before and after formation of the nanostructures. In some embodiments, the tensile strength of the nanopositor support is less than about 20% lower, less than about 10% lower, less than about 5% lower, or less than about 1% lower than the tensile strength of a nanopositor support exposed to essentially identical conditions in the absence of the nanopositor. Suitable techniques for measuring the tensile strength of a single fiber (e.g., a carbon or graphite fiber) can be found, for example, in “Standard Test Method for Tensile Strength and Young's Modulus of Fibers,” ASTM International, Standard ASTM C 1557-03, West Conshohocken, Pa., 2003, which is incorporated herein by reference in its entirety. Suitable techniques for measuring the tensile strength of other nanopositor supports may be found, for example, in M. Madou, “Fundamentals of Microfabrication,” 2nd edition, CRC Press (2002), which is incorporated herein by reference in its entirety.

The nanopositors described herein may be of any suitable form. For example, in some cases, the nanopositor may comprise a film (e.g., positioned on a nanopositor support such as a growth substrate). In some instances, the nanopositor may be deposited on a nanopositor support (e.g., growth substrate) in a pattern (e.g., lines, dots, or any other suitable form).

In some cases, the nanopositor may comprise a series of nano-scale features. As used herein, a “nanoscale feature” refers to a feature, such as a protrusion, groove or indentation, particle, or other measurable geometric feature on an article that has at least one cross-sectional dimension of less than about 1 micron. In some cases, the nanoscale feature may have at least one cross-sectional dimension of less than about 500 nm, less than about 250 nm, less than about 100 nm, less than about 10 nm, less than about 5 nm, less than about 3 nm, less than about 2 nm, less than about 1 nm, between about 0.3 and about 10 nm, between about 10 nm and about 100 nm, or between about 100 nm and about 1 micron. Not wishing to be bound by any theory, the nano-scale feature may increase the rate at which a reaction, nucleation step, or other process involved in the formation of a nanostructure occurs. Nanoscale features can be formed, for example, by roughening the surface of a nanopositor.

In some instances, the nanopositor may comprise nanoparticles. Generally, the term “nanoparticle” is used to refer to any particle having a maximum cross-sectional dimension of less than about 1 micron. In some embodiments, a nanopositor nanoparticle may have a maximum cross-sectional dimension of less than about 500 nm, less than about 250 nm, less than about 100 nm, less than about 10 nm, less than about 5 nm, less than about 3 nm, less than about 2 nm, less than about 1 nm, between about 0.3 and about 10 nm, between about 10 nm and about 100 nm, or between about 100 nm and about 1 micron. A plurality of nanopositor nanoparticles may, in some cases, have an average maximum cross-sectional dimension of less than about 1 micron, less than about 100 nm, less than about 10 nm, less than about 5 nm, less than about 3 nm, less than about 2 nm, less than about 1 nm, between about 0.3 and about 10 nm, between about 10 nm and about 100 nm, or between about 100 nm and about 1 micron. As used herein, the “maximum cross-sectional dimension” refers to the largest distance between two opposed boundaries of an individual structure that may be measured. The “average maximum cross-sectional dimension” of a plurality of structures refers to the number average.

In some instances, the nanopositor particles may be substantially the same shape and/or size (“monodisperse”). For example, the nanopositor particles may have a distribution of dimensions such that the standard deviation of the maximum cross-sectional dimensions of the nanopositor particles is no more than about 50%, no more than about 25%, no more than about 10%, no more than about 5%, no more than about 2%, or no more than about 1% of the average maximum cross-sectional dimensions of the nanopositor particles. Standard deviation (lower-case sigma) is given its normal meaning in the art, and may be calculated as:

$$σ = \sqrt{\frac{{\sum }_{i = 1}^{n} {( {D}_{i} - {D}_{avg} )}^{2}}{n - 1}}$$

wherein Dᵢ is the maximum cross-sectional dimension of nanopositor particle i, D_{avg} is the average of the cross-sectional dimensions of the nanopositor particles, and n is the number of nanopositor particles. The percentage comparisons between the standard deviation and the average maximum cross-sectional dimensions of the nanopositor particles outlined above can be obtained by dividing the standard deviation by the average and multiplying by 100%.

The nanopositors described herein may be prepared via a variety of methods. For example, in some embodiments, nanopositors comprising metal or metalloid atoms in a non-zero oxidation state may be prepared via reduction of a salt or oxidation of a metal, metalloid, or carbide. Zirconium oxide nanopositors may be, for example, prepared from sol-gel precursors such as zirconium propoxide. In some instances, zirconium oxide particles may be prepared from reduction of zirconium oxychloride (ZrOCl₂) or from the oxidation of zirconium metal or zirconium carbide nanoparticles or thin films. In some embodiments, the nanopositor may be prepared via e-beam deposition or sputter deposition. One or more dopants may be included in the nanopositor by, for example, ball-milling the dopant material into the deposition target (e.g., an e-beam target), and subsequently depositing the material in the target. In some embodiments, the dopant may be incorporated into the precursor material from which the nanopositor is formed via chemical vapor deposition. For example, the dopant may be incorporated into a sol, in some embodiments.

A variety of nanopositor supports (e.g., growth substrates) may be used in accordance with the systems and methods described herein. Nanopositor supports (e.g., growth substrates) may comprise any material capable of supporting nanopositors and/or nanostructures as described herein. For example, in some cases, the nanopositor support can include silicon, a ceramic, a metal, a polymer, carbon (e.g., amorphous carbon, carbon aerogel, carbon fiber, graphite, glassy carbon, carbon-carbon composite, graphene, diamond (e.g., aggregated diamond nanorods, nanodiamond, etc.), and the like), or a combination of these.

The nanopositor support (e.g., growth substrate) may be selected to be inert to and/or stable under sets of conditions used in a particular process, such as nanostructure growth conditions, nanostructure removal conditions, and the like. In some cases, the nanopositor support comprises a substantially flat surface. In some cases, the nanopositor support comprises a substantially nonplanar surface. For example, the nanopositor support may comprise a cylindrical surface. Nanopositor supports suitable for use in the invention include high-temperature prepregs, high-temperature polymer resins, inorganic materials such as metals, alloys, intermetallics, metal oxides, metal nitrides, ceramics, and the like. As used herein, the term “prepreg” refers to one or more layers of thermoset or thermoplastic resin containing embedded fibers, for example fibers of carbon, glass, silicon carbide, and the like. In some cases, the nanopositor support may be a fiber, tow of fibers, a weave (e.g., a dry weave), and the like. The nanopositor support may further comprise a conducting material, such as conductive fibers, weaves, or nanostructures.

In some embodiments, the nanopositor supports (e.g., growth substrates) are reactive with zero-oxidation-state metals and/or carbides, but are not reactive with oxides or other materials comprising metals or metalloids in a non-zero oxidation state. Also, nanopositor supports may comprise, in some cases, a material upon which growth of nanostructures would be inhibited due to unfavorable chemical reactions between the nanopositor support and a zero-oxidation-state metal and/or metal-carbide nanopositor, but does not react with metal oxides, metalloid oxides, or other materials comprising metals or metalloids in a non-zero oxidation state.

In some cases, the nanopositor support (e.g., growth substrates) as described herein may comprise polymers capable of withstanding the conditions under which nanostructures are grown. Examples of suitable polymers that can be used in the nanopositor support include, but are not limited to, relatively high temperature fluoropolymers (e.g., Teflon®), polyetherether ketone (PEEK), and polyether ketone (PEK), and the like.

In some embodiments, the nanopositor supports (e.g., growth substrates) used herein are substantially transparent to electromagnetic radiation. For example, in some cases, the substrate may be substantially transparent to visible light, ultraviolet radiation, infrared radiation, microwave radiation, or radar frequencies.

In some cases, the nanostructures may be grown on the nanopositor support (e.g., growth substrate) during formation of the nanopositor support itself. For example, fibers (e.g., graphite fibers) may be formed in a continuous process, in combination with nanostructure fabrication as described herein. In an illustrative embodiment, carbon fibers comprising nanostructures on the surface of the fibers may formed at elevated temperature by first stabilizing the carbon fiber precursor material, typically under stress at elevated temperature, followed by carbonization and or graphitization pyrolysis steps at elevated temperatures (e.g., greater than 500° C.) to form the fiber. The nanostructures may be grown on the surface of the fibers, followed by surface treatments, sizing, spooling, or other processing techniques.

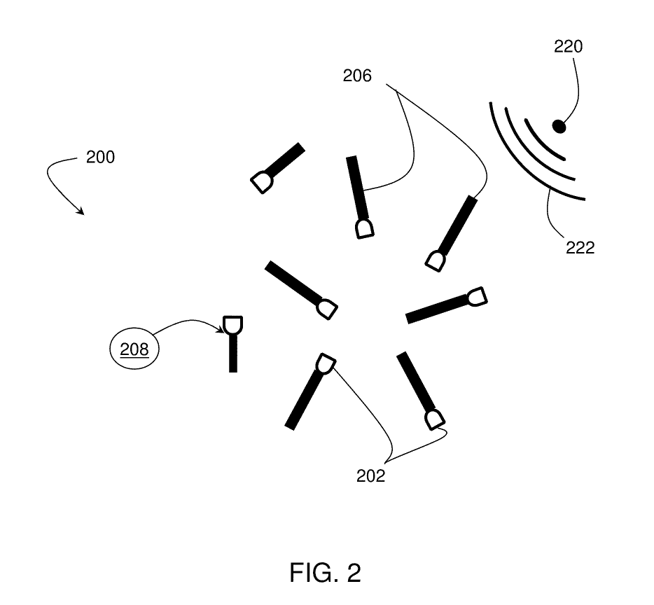

While growth of nanostructures using a growth substrate has been described in detail, the embodiments described herein are not so limited, and nanostructures may be formed, in some embodiments, in the absence of a growth substrate. For example, FIG. 2 includes a schematic illustration of system 200 in which nanopositor 202 is placed under a set of conditions selected to facilitate nanostructure growth in the absence of a growth substrate in contact with the nanopositor. Nanostructures 206 may grow from nanopositor 202 as the nanopositor is exposed to precursor 208 and suitable growth conditions. In some embodiments, the precursor and/or the nanopositor can be exposed to electromagnetic radiation 222 from source 220. The nanopositor can be, in some cases, suspended in a fluid. For example, a nanopositor may be suspended in a gas (e.g., aerosolized) and subsequently exposed to a carbon-containing precursor material, from which carbon nanotubes may be grown. In some cases, the nanopositor may be suspended in a liquid (e.g., an alcohol that serves as a nanostructure precursor material) during the formation of the nanostructures.

In another set of embodiments, a system for growing carbon-based nanostructures is described. In some embodiments, the system can include a nanopositor (e.g., nanopositors 102 in FIG. 1A, nanopositors 202 in FIG. 2) and a precursor of a carbon-based nanostructure (e.g., precursor 108 in FIG. 1A, precursor 208 in FIG. 2). In some embodiments the system can further include an auxiliary source of electromagnetic radiation constructed and arranged to expose at least one of the nanopositor and the precursor to a wavelength of electromagnetic radiation. For example, the set of embodiments illustrated in FIG. 1A includes source 120 from which electromagnetic radiation 122 is emitted, while the set of embodiments illustrated in FIG. 2 includes source 220 from which electromagnetic radiation 222 is emitted.

As used herein, exposure to a “set of conditions” may comprise, for example, exposure to a particular temperature, pH, solvent, chemical reagent, type of atmosphere (e.g., nitrogen, argon, oxygen, etc.), and the like. In some cases, the set of conditions may be selected to facilitate nucleation, growth, stabilization, removal, and/or other processing of nanostructures. In some cases, the set of conditions may be selected to facilitate reactivation, removal, and/or replacement of the nanopositor. In some cases, the set of conditions may be selected to maintain the activity of the nanopositor. Some embodiments may comprise a set of conditions comprising exposure to a source of external energy, in addition to electromagnetic radiation, such as, for example, electrical energy, sound energy, thermal energy, or chemical energy. For example, the set of conditions can comprise exposure to heat or resistive heating. In some embodiments, the set of conditions comprises exposure to a particular temperature, pressure, chemical species, and/or nanostructure precursor material. For example, in some cases, exposure to a set of conditions comprises exposure to substantially atmospheric pressure (i.e., about 1 atm or 760 torr). In some cases, exposure to a set of conditions comprises exposure to a pressure of less than about 1 atm (e.g., less than about 100 torr, less than about 10 torr, less than about 1 torr, less than about 0.1 torr, less than about 0.01 torr, or lower). In some cases, the use of high pressure may be advantageous. For example, in some embodiments, exposure to a set of conditions comprises exposure to a pressure of at least about 2 atm, at least about 5 atm, at least about 10 atm, at least about 25 atm, or at least about 50 atm. In some instances, the set of conditions comprises exposure to a temperature below about 1100° C., below about 1050° C., below about 1000° C., below about 900° C., below about 800° C., below about 700° C., below about 600° C., below about 500° C., below about 400° C., above about 300° C., above about 400° C., above about 500° C., above about 600° C., above about 700° C., above about 800° C., above about 900° C., above about 1000° C., above about 1050° C., or between about 300° C. and about 500° C., between about 300° C. and about 1100° C., between about 300° C. and about 1050° C., between about 300° C. and about 1000° C., between about 300° C. and about 900° C., between about 300° C. and about 500° C., between about 500° C. and about 900° C., between about 500° C. and about 1000° C., between about 500° C. and about 1050° C., or between about 500° C. and about 1100° C. In some embodiments, exposure to a set of conditions comprises performing chemical vapor deposition (CVD) of nanostructures on the nanopositor. In some embodiments, the chemical vapor deposition process may comprise a plasma chemical vapor deposition process. Chemical vapor deposition is a process known to those of ordinary skill in the art, and is explained, for example, in Dresselhaus M S, Dresselhaus G., and Avouris, P. eds. “Carbon Nanotubes: Synthesis, Structure, Properties, and Applications” (2001) Springer, which is incorporated herein by reference in its entirety.

In some embodiments, the systems and methods described herein may be used to produce substantially aligned nanostructures. The substantially aligned nanostructures may have sufficient length and/or diameter to enhance the properties of a material when arranged on or within the material. In some embodiments, the set of substantially aligned nanostructures may be formed on a surface of a growth substrate, and the nanostructures may be oriented such that the long axes of the nanostructures are substantially non-planar with respect to the surface of the growth substrate. In some cases, the long axes of the nanostructures are oriented in a substantially perpendicular direction with respect to the surface of the growth substrate, forming a nanostructure array or “forest.” The alignment of nanostructures in the nanostructure “forest” may be substantially maintained, even upon subsequent processing (e.g., transfer to other surfaces and/or combining the forests with secondary materials such as polymers), in some embodiments. Systems and methods for producing aligned nanostructures and articles comprising aligned nanostructures are described, for example, in International Patent Application Serial No. PCT/US2007/011914, filed May 18, 2007, entitled “Continuous Process for the Production of Nanostructures Including Nanotubes”; and U.S. Pat. No. 7,537,825, issued on May 26, 2009, entitled “Nano-Engineered Material Architectures: Ultra-Tough Hybrid Nanocomposite System,” which are incorporated herein by reference in their entirety.

In some cases, a source of external energy may be coupled with the growth apparatus to provide energy to cause the growth sites to reach the necessary temperature for growth. The source of external energy may provide thermal energy, for example, by resistively heating a wire coil in proximity to the growth sites (e.g., nanopositor) or by passing a current through a conductive nanopositor support such as a growth substrate. In some case, the source of external energy may provide an electric and/or magnetic field to the nanopositor support (e.g., growth substrate). In some cases, the source of external energy may provided via magnetron heating or via direct, resistive heating the nanopositor support (e.g., growth substrate), or a combination of one or more of these. In an illustrative embodiment, the set of conditions may comprise the temperature of the nanopositor support surface (e.g., growth substrate surface), the chemical composition of the atmosphere surrounding the nanopositor support (e.g., growth substrate), the flow and pressure of reactant gas(es) (e.g., nanostructure precursors) surrounding the nanopositor support surface and within the surrounding atmosphere, the deposition or removal of nanopositor, or other materials, on the surface of the growth surface, and/or optionally the rate of motion of the nanopositor support.

In some cases, the nanostructures may be removed from a nanopositor and/or nanopositor support (e.g., growth substrate) after the nanostructures are formed. For example, the act of removing may comprise transferring the nanostructures directly from the surface of the nanopositor and/or nanopositor support (e.g., growth substrate) to a surface of a receiving substrate. The receiving substrate may be, for example, a polymer material or a carbon fiber material. In some cases, the receiving substrate comprises a polymer material, metal, or a fiber comprising Al₂O₃, SiO₂, carbon, or a polymer material. In some cases, the receiving substrate comprises a fiber comprising Al₂O₃, SiO₂, carbon, or a polymer material. In some embodiments, the receiving substrate is a fiber weave.

Removal of the nanostructures may comprise application of a mechanical tool, mechanical or ultrasonic vibration, a chemical reagent, heat, or other sources of external energy, to the nanostructures, the nanopositor, and/or the surface of the nanopositor support (e.g., growth substrate). In some cases, the nanostructures may be removed by application of compressed gas, for example. In some cases, the nanostructures may be removed (e.g., detached) and collected in bulk, without attaching the nanostructures to a receiving substrate, and the nanostructures may remain in their original or “as-grown” orientation and conformation (e.g., in an aligned “forest”) following removal from the nanopositor and/or nanopositor support (e.g., growth substrate). Systems and methods for removing nanostructures from a substrate, or for transferring nanostructures from a first substrate to a second substrate, are described in International Patent Application Serial No. PCT/US2007/011914, filed May 18, 2007, entitled “Continuous Process for the Production of Nanostructures Including Nanotubes,” which is incorporated herein by reference in its entirety.

In some embodiments, the nanopositor may be removed from the nanopositor support (e.g., growth substrate) and/or the nanostructures after the nanostructures are grown. Nanopositor removal may be performed mechanically, for example, via treatment with a mechanical tool to scrape or grind the nanopositor from a surface (e.g., of a nanopositor and/or nanopositor support). In some cases, the first nanopositor may be removed by treatment with a chemical species (e.g., chemical etching) or thermally (e.g., heating to a temperature which evaporates the nanopositor). For example, in some embodiments, the nanopositor may be removed via an acid etch (e.g., HCl, HF, etc.), which may, for example, selectively dissolve the nanopositor. For example, HF can be used to selectively dissolve oxides.

In some embodiments, a carbon-based nanostructure may have a least one cross-sectional dimension of less than about 500 nm, less than about 250 nm, less than about 100 nm, less than about 75 nm, less than about 50 nm, less than about 25 nm, less than about 10 nm, or, in some cases, less than about 1 nm. Carbon-based nanostructures described herein may have, in some cases, a maximum cross-sectional dimension of less than about 1 micron, less than about 500 nm, less than about 250 nm, less than about 100 nm, less than about 75 nm, less than about 50 nm, less than about 25 nm, less than about 10 nm, or, in some cases, less than about 1 nm.

In some embodiments, the carbon-based nanostructures described herein may comprise carbon nanotubes. As used herein, the term “carbon nanotube” is given its ordinary meaning in the art and refers to a substantially cylindrical molecule or nanostructure comprising a fused network of primarily six-membered rings (e.g., six-membered aromatic rings) comprising primarily carbon atoms. In some cases, carbon nanotubes may resemble a sheet of graphite formed into a seamless cylindrical structure. It should be understood that the carbon nanotube may also comprise rings or lattice structures other than six-membered rings. Typically, at least one end of the carbon nanotube may be capped, i.e., with a curved or nonplanar aromatic structure. Carbon nanotubes may have a diameter of the order of nanometers and a length on the order of millimeters, or, on the order of tenths of microns, resulting in an aspect ratio greater than 100, 1000, 10,000, 100,000, 10⁶, 10⁷, 10⁸, 10⁹, or greater. Examples of carbon nanotubes include single-walled carbon nanotubes (SWNTs), double-walled carbon nanotubes (DWNTs), multi-walled carbon nanotubes (MWNTs) (e.g., concentric carbon nanotubes), inorganic derivatives thereof, and the like. In some embodiments, the carbon nanotube is a single-walled carbon nanotube. In some cases, the carbon nanotube is a multi-walled carbon nanotube (e.g., a double-walled carbon nanotube). In some cases, the carbon nanotube may have a diameter less than about 1 micron, less than about 500 nm, less than about 250 nm, less than about 100 nm, less than about 50 nm, less than about 25 nm, less than about 10 nm, or, in some cases, less than about 1 nm.

A “maximum cross-sectional diameter” of a carbon-based nanostructure, as used herein, refers to the largest diameter between two points on opposed outer boundaries of the carbon-based nanostructure, as measured perpendicular to the length of the nanostructure (e.g., the length of a carbon nanotube). A “maximum cross-sectional inner diameter” of a carbon-based nanostructure refers to the largest diameter between two points on opposed inner boundaries of the carbon-based nanostructure, as measured perpendicularly to the length of the carbon-based nanostructure. An inner boundary can correspond to, for example, the inner surface of a wall of a carbon nanotube (e.g., the inner surface of the wall of a single-walled carbon nanotube, the inner surface of the inner wall in the case of a multi-walled nanotube). For example, in the case of a single-walled carbon nanotube, the maximum cross-sectional inner diameter can correspond to the largest diameter measured between two opposed points on the inner surface of the wall of the single-walled carbon nanotube. In the case of a multi-walled carbon nanotube, the maximum cross-sectional inner diameter can correspond to the largest diameter measured between two opposed points on the inner surface of the innermost carbon nanotube. The averages of these measurements among a plurality of carbon-based nanostructures can be calculated as a number average.

In some embodiments, the systems and methods described herein may be particularly suited for forming carbon nanotubes. In some instances, conditions are selected such that carbon nanotubes are selectively produced. In many cases, conditions (e.g., temperature, pressure, etc.) that lead to the production of other carbon-based nanostructures, such as graphene, cannot be successfully used to produce nanotubes. In some cases, carbon nanotubes will not grow on traditional nanopositors from which graphene will grow.

In one set of embodiments, the nanopositors described herein, in combination with other processing conditions (e.g., temperature, pressure, etc.), can be used to form carbon-based nanostructures from solid precursors. Traditionally, carbon-based nanostructures have been formed from non-solid nanostructure precursors (e.g., gases, liquids, plasmas, etc.). The process for forming carbon-based nanostructures from solid precursors is fundamentally different from the process for forming carbon-based nanostructures from non-solid precursors. The inventors have unexpectedly discovered, however, that such differences can be overcome to form carbon-based nanostructures from solids.

The term “oxidation state” refers to the standard adopted by the International Union of Pure and Applied Chemistry (IUPAC) as described in the “IUPAC Compendium of Chemical Terminology,” Second Edition (1997), which is incorporated herein by reference in its entirety.

As used herein, the term “metal” includes the following elements: lithium, sodium, potassium, rubidium, cesium, francium, beryllium, magnesium, calcium, strontium, barium, radium, zinc, molybdenum, cadmium, scandium, titanium, vanadium, chromium, manganese, iron, cobalt, nickel, copper, yttrium, zirconium, niobium, technetium, ruthenium, rhodium, palladium, silver, hafnium, tantalum, tungsten, rhenium, osmium, iridium, platinum, gold, mercury, rutherfordium, dubnium, seaborgium, bohrium, hassium, meitnerium, darmstadtium, roentgenium, ununbium, aluminium, gallium, indium, tin, thallium, lead, bismuth, ununtrium, ununquadium, ununpentium, ununhexium, lanthanum, cerium, praseodymium, neodymium, promethium, samarium, europium, gadolinium, terbium, dysprosium, holmium, erbium, thulium, ytterbium, lutetium, actinium, thorium, protactinium, uranium, neptunium, plutonium, americium, curium, berkelium, californium, einsteinium, fermium, mendelevium, nobelium, and lawrencium.

The term “metalloid,” as used herein, includes the following elements: boron, silicon, germanium, arsenic, antimony, tellurium, and polonium.

As used herein, the term “non-metal” includes the following elements: hydrogen, carbon, nitrogen, phosphorous, oxygen, sulfur, selenium, fluorine, chlorine, bromine, iodine, astatine, helium, neon, argon, krypton, xenon, and radon, and ununoctium.

The following patents and patent applications are incorporated herein by reference in their entireties for all purposes: International Patent Application Serial No. PCT/US2007/011914, filed May 18, 2007, entitled “Continuous Process for the Production of Nanostructures Including Nanotubes,” published as WO 2007/136755 on Nov. 29, 2007; International Patent Application Serial No. PCT/US07/11913, filed May 18, 2007, entitled “Nanostructure-reinforced Composite Articles and Methods,” published as WO 2008/054541 on May 8, 2008; International Patent Application Serial No. PCT/US2008/009996, filed Aug. 22, 2008, entitled “Nanostructure-reinforced Composite Articles and Methods,” published as WO 2009/029218 on Mar. 5, 2009; U.S. Pat. No. 7,537,825, issued on May 26, 2009, entitled “Nano-Engineered Material Architectures: Ultra-Tough Hybrid Nanocomposite System”; U.S. patent application Ser. No. 11/895,621, filed Aug. 24, 2007, entitled “Nanostructure-Reinforced Composite Articles,” published as U.S. Patent Application Publication No. 2008/0075954 on Mar. 27, 2008; U.S. Provisional Patent Application 61/114,967, filed Nov. 14, 2008, entitled “Controlled-Orientation Films and Nanocomposites Including Nanotubes or Other Nanostructures”; U.S. patent application Ser. No. 12/618,203, filed Nov. 13, 2009, entitled “Controlled-Orientation Films and Nanocomposites Including Nanotubes or Other Nanostructures,” published as U.S. Patent Application Publication No. 2010/0196695 on Aug. 5, 2010; U.S. Provisional patent application Ser. No. 12/630,289, filed Dec. 3, 2009, entitled “Multifunctional Composites Based on Coated Nanostructures”; U.S. patent application Ser. No. 12/847,905, filed Jul. 30, 2010, entitled “Systems and Methods Related to the Formation of Carbon-Based Nanostructures”; and U.S. Provisional Patent Application No. 61/264,506, filed Nov. 25, 2009, and entitled “Systems and Methods for Enhancing Growth of Carbon-Based Nanostructures.” The articles, systems, and methods described herein may be combined with those described in any of the patents and/or patent applications noted above. All patents and patent applications mentioned herein are incorporated herein by reference in their entirety for all purposes.

The following example is intended to illustrate certain embodiments of the present invention, but does not exemplify the full scope of the invention.

### Example

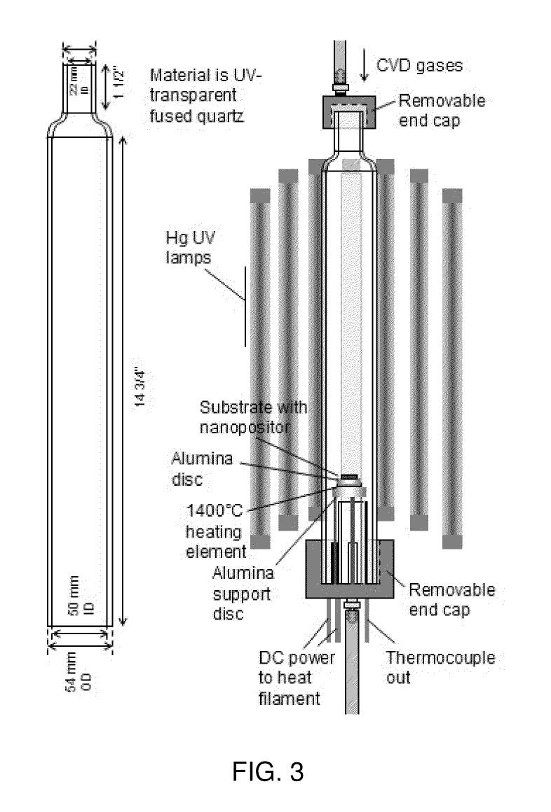

This example describes a set of experiments in which electromagnetic radiation was used in a carbon nanotube growth system. A schematic diagram of the experimental setup is shown in FIG. 3. 1% Ca-doped zirconia particles, ranging from a few nanometers to a few microns in maximum cross-sectional dimension, served as the nanopositor. The particles were deposited on a silicon substrate on which a 200 nm thermal SiO₂ film was grown. The substrate was mounted on an alumina disc, which was, in turn, mounted on a thermally insulated alumina mount including a resistive heating element. The alumina disc and the alumina mount were arranged such that they did not participate in the growth process. The substrate was positioned within a UV-transparent fused quartz tube approximately 14.75 inches in length and 50 mm in inner diameter.

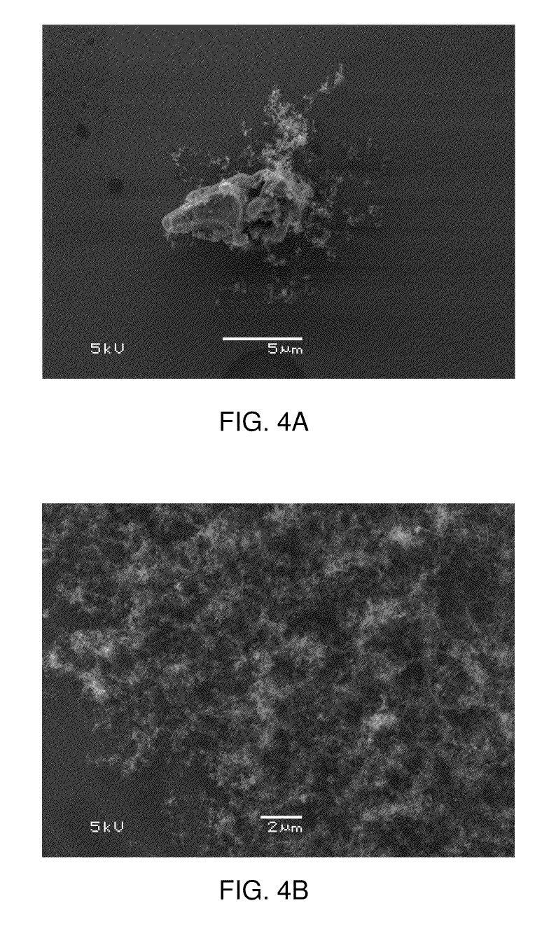

In the first set of experiments, the nanopositor was exposed to a 5:1 mixture of H₂:C₂H₄ at 480° C. in the absence of ultraviolet light, and carbon nanotubes were grown. The resulting growth is illustrated in the scanning electron microscope (SEM) micrograph in FIG. 4A. The growth of carbon nanotubes was sparse, and the zirconia nanopositor remained clearly visible.

In a second set of experiments, the nanopositor was exposed to a 5:1 mixture of H₂:C₂H₄ at 480° C., but in the presence of ultraviolet radiation at 6 W. Carbon nanotubes were growth for about 30 minutes, producing lengths of about 20 microns. The resulting growth is shown in the SEM micrograph in FIG. 4B. In these experiments, the zirconia nanopositor was substantially covered with carbon nanotubes.

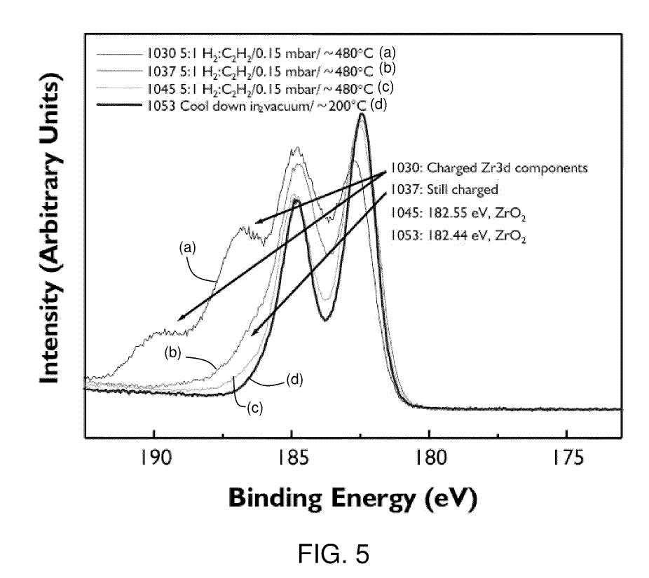

FIG. 5 includes XPS spectra during various phases of thermal chemical vapor deposition growth of carbon nanotubes. Not wishing to be bound by any theory, the high-binding energy peaks may be attributable to a charged state that appeared upon exposure of the nanopositor to X-rays, resulting in enhanced carbon nanotube growth.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of growing carbon-based nanostructures, comprising:
providing a nanopositor;
exposing the nanopositor to a precursor of a carbon-based nanostructure under conditions causing the formation of carbon-based nanostructures; and
exposing at least one of the nanopositor and the precursor to electromagnetic radiation of intensity and energy selected to create a changed state of a component within the nanopositor, or a component in the precursor, or both, which changed state enhances formation of the carbon-based nanostructure.

2. A method of growing carbon-based nanostructures, comprising:
providing a nanopositor;
exposing the nanopositor to a precursor of a carbon-based nanostructure under conditions causing the formation of carbon-based nanostructures; and
exposing at least one of the nanopositor and the precursor to auxiliary electromagnetic radiation.

3. A system for growing carbon-based nanostructures, comprising:
a nanopositor;
a precursor of a carbon-based nanostructure; and
an auxiliary source of electromagnetic radiation constructed and arranged to expose at least one of the nanopositor and the precursor of a carbon-based nanostructure to a wavelength of electromagnetic radiation.

4. A method as in claim 1, wherein exposing at least one of the nanopositor and the precursor to electromagnetic radiation enables formation of nanostructures that would otherwise not substantially occur in the absence of the electromagnetic radiation, but under essentially identical conditions.

5. A method as in claim 1, comprising modulating the intensity or energy of the electromagnetic radiation to increase a yield of carbon-based nanostructures.

6. A method as in claim 1, comprising modulating the intensity or energy of the electromagnetic radiation to increase an average length of the carbon-based nanostructures.

7. A method as in claim 1, comprising modulating the intensity or energy of the electromagnetic radiation to increase an average maximum cross-sectional diameter of the carbon-based nano structures.

8. A method as in claim 1, comprising modulating the intensity or energy of the electromagnetic radiation to increase an average maximum cross-sectional inner diameter of the carbon-based nanostructures.

9. A method as in claim 1, comprising exposing the nanopositor to electromagnetic radiation of intensity and energy selected to create a changed state of a component within the nanopositor.

10. A method as in claim 1, comprising exposing the precursor of a carbon-based nanostructure to electromagnetic radiation of intensity and energy selected to create a changed state of a component within the precursor.

11. A method as in claim 1, comprising exposing both the nanopositor and the precursor of a carbon-based nanostructure to electromagnetic radiation of intensity and energy selected to create a changed state of a component within the nanopositor and a component of the precursor.

12. A method as in claim 1, wherein the electromagnetic radiation comprises photons with energies exceeding the bandgap energy of a component of the nanopositor.

13. A method as in claim 1, wherein the bandgap energy of a component of the nanopositor is between about 0.5 eV and about 6.0 eV.

14. A method as in claim 1, wherein the electromagnetic radiation comprises photons with energies substantially equivalent to the bandgap energy of a component of the nanopositor.

15. A method as in claim 1, wherein the electromagnetic radiation comprises a wavelength substantially equal to a characteristic absorption wavelength of a component of the precursor of a carbon-based nanostructure.

16. A method as in claim 1, wherein the electromagnetic radiation comprises a wavelength shorter than visible light.

17. A method as in claim 1, wherein the electromagnetic radiation comprises ultraviolet electromagnetic radiation.

18. A method as in claim 1, wherein the electromagnetic radiation comprises X-ray electromagnetic radiation.

19. A method as in claim 1, wherein the carbon-based nanostructures comprise carbon nanotubes.

20. A method as in claim 19, wherein the carbon nanotubes comprise single-walled carbon nanotubes.

21. A method as in claim 19, wherein the carbon nanotubes comprise multi-walled carbon nanotubes.

22. A method as in claim 1, wherein the carbon-based nanostructures comprise single or multi-layered graphene.

23. A method as in claim 1, wherein the average of the lengths of the carbon-based nanostructures are at least about 25% longer than the average of the lengths that would be observed in the absence of the electromagnetic radiation, but under otherwise essentially identical conditions.

24. A method as in claim 1, wherein the yield of the carbon-based nanostructures is at least about 25% greater than the yield of carbon-based nanostructures that would be observed in the absence of the electromagnetic radiation, but under otherwise essentially identical conditions.

25. A method as in claim 1, wherein:
the carbon-based nanostructures comprise a plurality of elongated carbon-based nanostructures, and
the average maximum cross-sectional diameter of the plurality of elongated carbon-based nanostructures is at least about 25% larger than the average maximum cross-sectional diameter achievable in the absence of electromagnetic radiation, but under otherwise essentially identical conditions.

26. A method as in claim 1, wherein:
the carbon-based nanostructures comprise a plurality of carbon nanotubes, and
the average maximum cross-sectional inner diameter of the plurality of carbon nanotubes is at least about 25% larger than the average maximum cross-sectional inner diameter achievable in the absence of electromagnetic radiation, but under otherwise essentially identical conditions.

27. A method as in claim 1, wherein the average maximum cross-sectional dimension of the carbon-based nanostructures is at least about 1 mm.

28-30. (canceled)

31. A method as in claim 1, wherein the electromagnetic radiation comprises auxiliary electromagnetic radiation.

32. A method as in claim 1, wherein the nanopositor is in contact with a growth substrate.

33. A method as in claim 1, wherein the nanopositor is not in contact with a growth substrate.

34. A method as in claim 32, wherein the growth substrate comprises at least one of silicon, a ceramic, a metal, a polymer, a prepreg, amorphous carbon, a carbon aerogel, a carbon fiber, graphite, glassy carbon, a carbon-carbon composite, graphene, and diamond.

35. A method as in claim 1, wherein the exposing step comprises exposing the nanopositor to a precursor of a carbon-based nanostructure such that the precursor contacts the nanopositor.

36. A method as in claim 1, wherein the precursor of a carbon-based nanostructure comprises a fluid.

37. A method as in claim 1, wherein the precursor of a carbon-based nanostructure comprises at least one of a hydrocarbon and an alcohol.

38. A method as in claim 1, wherein the precursor of a carbon-based nanostructure comprises at least one of an alkyne, an alkene, and hydrogen.

39. A method as in claim 1, wherein the precursor of a carbon-based nanostructure comprises at least one of acetylene, 1-propyne, 1,3.-butadiyne, but-1-en-3-yne, and 1,3-cyclopentadiene.

40. A method as in claim 1, wherein the precursor of a carbon-based nanostructure comprises a solid.

41. A method as in claim 40, wherein the solid precursor of a carbon-based nanostructure comprises at least one of coal, coke, amorphous carbon, unpyrolyzed organic polymers, partially pyrolyzed organic polymers, diamond, graphite.

42. A method as in claim 1, wherein the set of conditions comprises a pressure substantially equal to or less than about 1 atmosphere.

43. A method as in claim 1, wherein the set of conditions comprises a temperature between about 300-1100° C.

44. (canceled)

45. A method as in claim 1, wherein the nanopositor comprises at least one of metal atoms in a non-zero oxidation state and metalloid atoms in a non-zero oxidation state during growth of the carbon-based nanostructures.

46. A method as in claim 1, wherein the nanopositor comprises metal atoms in a non-zero oxidation state during growth of the carbon-based nanostructures.

47. A method as in claim 1, wherein the nanopositor comprises metalloid atoms in a non-zero oxidation state during growth of the carbon-based nanostructures.

48. A method as in claim 1, wherein the nanopositor is in contact with a nanopositor support.

49. A method as in claim 1, wherein the nanopositor support comprises at least one of metal atoms in a non-zero oxidation state and metalloid atoms in a non-zero oxidation state during growth of the carbon-based nanostructures.

50. A method as in claim 1, wherein the nanopositor comprises metal atoms in a zero oxidation state during growth of the carbon-based nanostructures.

51. A method as in claim 50, wherein the metal atoms in a zero oxidation state comprise at least one of iron, cobalt, nickel, platinum, gold, copper, rhenium, tin, tantalum, aluminum, palladium, rhodium, silver, tungsten, molybdenum, and zirconium.

52. A method as in claim 48, wherein the nanopositor support comprises at least one of a metal oxide, a metalloid oxide, a metal nitride, a metalloid nitride, a metal phosphide, a metalloid phosphide, a metal carbide, a metalloid carbide, and diamond.

53. A method as in claim 48, wherein the nanopositor support comprises at least one of a metal oxide and a metalloid oxide, and the nanopositor comprises metal atoms in a zero oxidation state during growth of the carbon-based nanostructures

54. A method as in claim 48, wherein a triple-phase boundary is formed between the nanopositor, the nanopositor support, and the precursor of a carbon-based nanostructure.

55. A method as in claim 1, wherein the nanopositor comprises at least one of a metal oxide, a metalloid oxide, a metal nitride, a metalloid nitride, a metal phosphide, a metalloid phosphide, a metal carbide, a metalloid carbide, and diamond.

56. A method as in claim 1, wherein the nanopositor comprises a dopant.

57. A method as in claim 56, wherein the dopant comprises at least one of Ca, Mg, Sr, Ba, Y, Sn, and Mo.

58-65. (canceled)

66. A method as in claim 1, wherein the changed state comprises an electronically excited state.

67. A method as in claim 1, wherein the changed state comprises the formation of an electron-hole pair within the nanopositor.

68. A method as in claim 1, wherein the changed state comprises the formation of a defect within the nanopositor.

69. A method as in claim 1, wherein the changed state comprises the formation of a charge state within the nanopositor.

70. A method as in claim 1, wherein the changed state comprises a change in the acidity of the nanopositor.

71. A method as in claim 1, wherein the changed state comprises a change of shape of the nanopositor.

72. A method as in claim 1, wherein the changed state comprises a change of an oxidation state of the nanopositor.

73. A method as in claim 1, wherein the changed state comprises a change in composition of the nanopositor.

74. A method as in claim 1, wherein the changed state comprises a change in the crystal phase of the nanopositor.

75. A method as in claim 1, wherein the nanopositor comprises at least one of zirconia, titania, molybdenum oxide, iron sulfide, and silicon nitride.
